(19) United States
(12) Patent Application Publication
(10) Pub. No.: US 2009/0216886 A1
(43) Pub. Date: Aug. 27, 2009

(54) Method of multi-path accessing remote logic device under linux system

(75) Inventors: Ming-Sheng Zhu, Tianjin (CN); Ji-Dong Wang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/071,487

(22) Filed: Feb. 21, 2008

(51) Int. Cl. G06F 15/16

(52) U.S. Cl. 709/227

(57) ABSTRACT

A method of multi-path accessing a remote logic device under a Linux system is used to realize a multi-path access between an initiator and a target in a storage area network (SAN). Firstly, a communication is established between the initiator and the target. Next, the initiator requests to establish at least one link session with the target. Then, the initiator obtains an iSCSI-connected host assigned by the target, and also obtains a message about connected devices corresponding to the iSCSI-connected host through transmitting a report logic unit number (LUN) command. Then, the initiator configures a device mapper, and the device mapper generates information about redundant devices according to the connected devices and the corresponding LUNs, and the redundant connected devices are mapped into a unique mapping device.

### BACKGROUND OF THE INVENTION

1. Field of the Invention

The present invention relates to a method of accessing a remote logic device, and more particularly to a method of multi-path accessing a remote logic device under a Linux system.

2. Related Art

Storage area network (SAN) refers to a technology for connecting a plurality of distributed storage devices in Internet into a large-scale virtual storage device according to the communication protocol standard of an internet Small Computer Systems Interface (iSCSI). A user accesses data in a remote logic disk through the SAN, like accessing data in a local hard disk. Compared with the conventional Redundant Arrays of Independent Disks (RAID) technology, the SAN established through using the iSCSI technology has both the high-speed transmission characteristic of a small computer system interface (SCSI) and a high expandability superior to a conventional storage device. Therefore, the SAN has gradually become a hot technology in the relevant field of information storage. The SAN includes two parts, i.e., an initiator and a target. The so-called initiator may be considered as the one requesting for the access service, whereas the target may be considered as the one for providing a storage device. The target generates a plurality of logic unit numbers (LUNs). Those LUNs are respectively corresponding to physical storage devices in the network. Once a session is established between the initiator and the target, the LUNs may be obtained at once and then assigned to the users. The user visits the LUNs and accesses the aforementioned physical storage devices through an iSCSI command. Generally, only one session may be established between the initiator and the target. If multi-path input/output is allowed to be established between the initiator and target, the efficacies of fault tolerance, backup and load balancing may be achieved.

Generally, a server installed under a Linux operating system is superior to that under the Windows operating system in the efficiency and stability. It means high system stability, if a service server adopting a Linux operating system. In addition, if the service server supports multi-path input/output and avoids data repetition, the system availability and data reliability may be enhanced. However, under the Linux operating system, some initiators and targets of the SAN cannot support the multi-path input/output at all. Moreover, although some initiators and targets do provide multi-path input/output, it may be found that the accessed data are identical when visiting different LUNs. Therefore, how to make the SAN support multi-path access under the Linux system and how to avoid the circumstance that two logic devices have the same content have become important issues in the field of SAN.

### SUMMARY OF THE INVENTION

In view of the above problems that the Linux system does not support multi-path access of remote logic devices, or the same data is obtained when accessing different LUNs, the present invention is directed to a method of multi-path accessing a remote logic device under a Linux system, in which all the connected devices in the connected hosts that access the same LUN are found out, and then grouped into a unique mapping device, so that each mapping device is mapped into a different LUN, so as to solve the above problem of accessing the same data.

In order to support the multi-path access of a remote logic device and to avoid the circumstance that the same data is obtained when accessing different LUNs, the present invention provides a method of multi-path accessing a remote logic device under a Linux system, which includes the following steps. Firstly, a communication is established between an initiator and a target. Next, the initiator requests to establish plurality of sessions with the target. Then, the initiator obtains at least one iSCSI-connected host assigned by the target. Then, the initiator obtaining a connected device messages from the corresponding iSCSI-connected host, through transmits a report LUN command. Finally, the initiator configures a device mapper, and the device mapper generates information about redundant devices according to the obtained connected device and the corresponding LUN, and maps the redundant connected devices into a unique mapping device (i.e., a mapped LUN). The so-called redundant connected devices refer to a plurality of connected devices that access the same LUN.

According to a preferred embodiment of the present invention, the communication may be a communication established according to a TCP communication protocol or an UDP communication protocol. The steps for establishing the link session are listed as follows. Firstly, the initiator transmits an iSCSI login request packet to the target; then, the target determines whether to permit an access request of the initiator or not according to a security authentication and a password parameter parsed from the iSCSI login request packet; and finally, the target feeds back an iSCSI login response packet to the initiator and establishes the link session.

According to a preferred embodiment of the present invention, the piggyback information of the iSCSI login response packet includes a connection permission instruction and a connection status. In addition, the report LUN command is loaded in a command description block of the iSCSI packet.

According to a preferred embodiment of the present invention, when one of the sessions is flow congestion, the device mapper performs a network diffluence means, so as to switch part of the flow to another mapping device for balancing the traffic load. In addition, when these sessions are interrupted, the device mapper switches to another mapping device to transmit a data packet.

Based upon the above, in the present invention, after the link session has been established, the target transmits a report LUN command to obtain the message about the connection devices of the iSCSI-connected host. Then, the initiator configures the device mapper to map the connected devices of the same LUN into a unique mapping device, thereby avoiding the circumstance that, when accessing different connected devices, it connects to the same LUN and accesses the same data.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a method of multi-path accessing a remote logic device under a Linux system according to a preferred embodiment of the present invention;

FIG. 2A is a schematic view of an iSCSI packet format according to a preferred embodiment of the present invention;

FIG. 2B is a schematic view of an iSCSI data unit in FIG. 2A including fields; and

FIG. 3 is a schematic view of a system architecture for implementing the multi-path access of the remote logic device according to a preferred embodiment of the present invention.

### DETAILED DESCRIPTION OF THE INVENTION

The objectives and the method provided in the present invention will be illustrated below in detail through the following preferred embodiments. However, the concept of the present invention may also be used in other scopes. The following embodiments are merely intended to illustrate the objectives and implementation manner of the present invention, but not intended to limit the scope of the present invention.

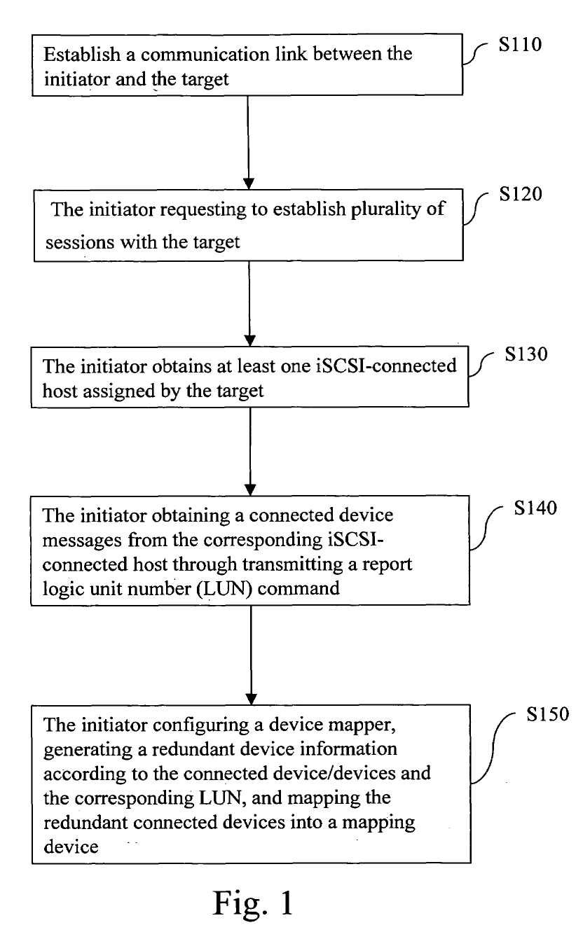

FIG. 1 is a flow chart of a method of multi-path accessing a remote logic device under a Linux system according to a preferred embodiment of the present invention. Referring to FIG. 1, in this embodiment, the method of multi-path accessing a remote logic device under Linux system is used to realize the multi-path access between an initiator and a target in the SAN. Firstly, a communication is established between the initiator and the target (Step S110). Next, the initiator requests to establish plurality of sessions with the target (Step S120). Then, the initiator obtains at least one iSCSI-connected host assigned by the target (Step S130). Then, the initiator obtaining a connected device messages from the corresponding iSCSI-connected host through transmits a report logic unit number (LUN) command (Step S140). Finally, the initiator configures a device mapper, and the device mapper generates a redundant device information according to the connected device/devices and the corresponding LUNs, and maps the redundant connected devices into a mapping device (Step S150), i.e., forming a unique mapped LUN.

Accordingly, a communication between the initiator and the target further is established through the following steps. Firstly, the initiator transmits an iSCSI logon request to the target. Next, the target parses a security authentication and a password parameter in the iSCSI login request packet. Once it is determined to be legal, an access request from the initiator is permitted. At this time, the target feeds back an iSCSI login response packet to the initiator, so as to establish a link session. In this embodiment, the communication is established through using a TCP communication protocol or a UDP communication protocol, which is not limited here.

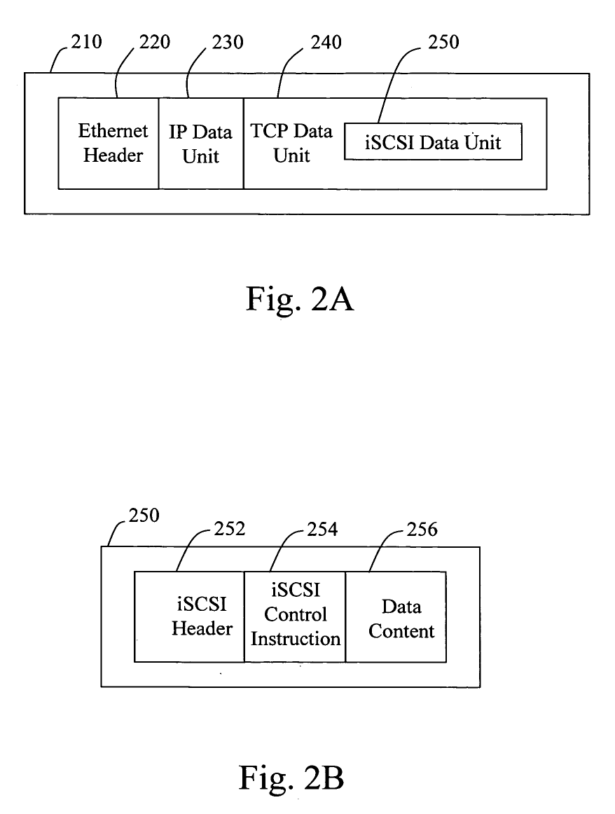

The piggyback information of the iSCSI packet (such as the iSCSI login request packet or the iSCSI login response packet) transmitted by the initiator and the target usually includes information such as a connection permission instruction and a connection status. Once the communication is established, the initiator loads a report LUN command in a command description block of the iSCSI packet. FIG. 2A is a schematic view of an iSCSI packet format according to a preferred embodiment of the present invention. Referring to FIG. 2A, the initiator wraps the instruction having the report LUN command in the command description block and packs it into an iSCSI data unit 250. Subsequently, the iSCSI data unit 250 is packed into a network packet 210 sequentially through a TCP data unit 240, an IP data unit 230, and an Ethernet header 220, which is transmitted to the target over Internet. FIG. 2B is a schematic view of an iSCSI data unit in FIG. 2A including fields. Referring to FIG. 2B, the iSCSI data unit 250 further includes an iSCSI header 252, an iSCSI control instruction 254, and data content 256. The report LUN command is written in the field 254 of the iSCSI control instruction, and the LUNs recorded in the target segment which may be accessed are all written into the data content 256.

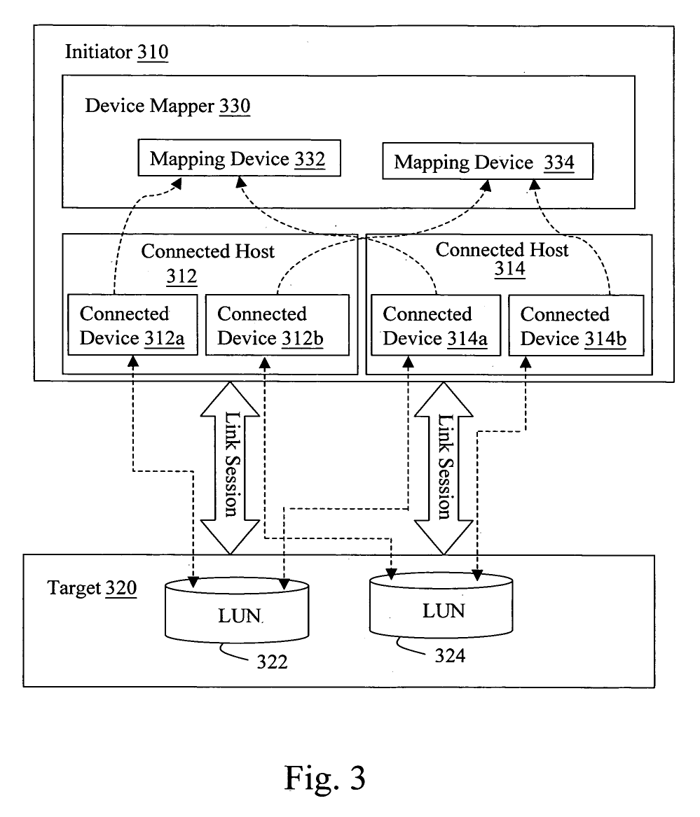

FIG. 3 is a schematic view of system architecture for implementing the multi-path access of the remote logic device according to a preferred embodiment of the present invention. Referring to FIG. 3, the initiator 310 firstly establishes a TCP communication with the target 320. Once the communication is established, the initiator 310 tries to establish a plurality of sessions with the target 320, in which the initiator 310 transmits the iSCSI login request packet to the target, and requests to establish plurality of communications. Then, the assigned iSCSI-connected hosts 312 and 314, and the corresponding LUNs 322 and 324 are obtained. The initiator transmits an iSCSI packet having the report LUN command, so as to obtain the message about the connected devices corresponding to the iSCSI-connected host, such as the type of the connected devices, speed and capacity for data storage, and even the manufacturer and model of the connected devices. In addition, the connected devices 312a and 312b corresponding to the connected host 312, and the connected devices 314a and 314b corresponding to the connected host 314 are obtained. Subsequently, the initiator configures a device mapper 330, and the device mapper 330 compares the LUNs 322 and 324 corresponding to the connected devices 312a, 312b, 314a, and 314b, and finds out the connected devices that are corresponding to the same LUN. For example, if the LUN corresponding to the connected device 312a and that corresponding to the connected device 314a are the LUN 322, the connected devices 312a and 314a are considered as redundant devices in the same group. Similarly, the connected devices 312b and 314b are considered as redundant devices in the same group corresponding to the LUN 324. The device mapper 330 records the information about the redundant devices, and maps the redundant connected devices into a mapping device (i.e., a mapped LUN). For example, the connected devices 312a and 314a are set as a mapping device 332, and the connected devices 312b and 314b are set as a mapping device 334. In FIG. 3, it can be seen that, when accessing two different mapping devices 332 and 334, different LUNs may be accessed through connection, thereby avoiding the circumstance that the same data is obtained when the same LUN is accessed through different paths.

Since each mapping device includes a plurality of connected devices, and the LUNs of the target may be accessed through different sessions, the network diffluence purpose may be achieved. For example, through the mapping device 332, the same LUN 322 may be accessed via different sessions established by different connected hosts (312 and 314), thereby achieving the network diffluence purpose. In addition, when one session is congestion, a network diffluence means is performed, so as to switch part of the flow to another mapping device for balancing the traffic load. When the link session is interrupted, another redundant connected device in the mapping device is used to access the original LUN in another path, and resumes the transmission of data packets, thereby avoiding the interruption of the connection.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of multi-path accessing a remote logic device under a Linux system, for realizing multi-path accessing a logic device between an initiator and a target in a storage area network (SAN), the method comprising:
(a) establishing a communication between an initiator and a target;
(b) the initiator requesting to establish plurality of sessions with the target;
(c) the initiator obtaining at least one iSCSI-connected host assigned by the target;
(d) the initiator obtaining a connected device messages from the corresponding iSCSI-connected host through transmitting a report logic unit number (LUN) command; and
(e) the initiator configuring a device mapper, generating a redundant device information according to the connected device(s) and the corresponding LUN, and mapping the redundant connected devices into a mapping device.

2. The method of multi-path accessing a remote logic device as claimed in claim 1, wherein a communication protocol adopted for establishing the communication is any one selected from a group consisting of a TCP communication protocol and a UDP communication protocol.

3. The method of multi-path accessing a remote logic device as claimed in claim 1, wherein Step (b) further comprises:
the initiator transmitting an iSCSI login request packet to the target;
the target determining whether to permit an access request of the initiator or not according to a security authentication and a password parameter parsed from the iSCSI login request packet; and
feeding back an iSCSI login response packet to the initiator and establishing the sessions.

4. The method of multi-path accessing a remote logic device as claimed in claim 3, wherein piggyback information of the iSCSI login response packet comprises a connection permission instruction and a connection status.

5. The method of multi-path accessing a remote logic device as claimed in claim 1, wherein the report LUN command is loaded in a command description block in an iSCSI packet.

6. The method of multi-path accessing a remote logic device as claimed in claim 1, wherein the redundant connected devices are connected devices accessing the same LUN.

7. The method of multi-path accessing a remote logic device as claimed in claim 1, wherein the device mapper performs a network diffluence means when one of the sessions is flow congestion, and switches part of the flow to another mapping device for balancing the traffic load.

8. The method of multi-path accessing a remote logic device as claimed in claim 1, wherein the device mapper switches to transmit a data packet through another mapping device when the sessions are interrupted.
